(19) United States
(12) Patent Application Publication
(10) Pub. No.: US 2018/0031017 A1
(43) Pub. Date: Feb. 1, 2018

(54) Telescopic Rod Assembly

(71) Applicant: Chih-Ching Chao, Nantou City (TW)

(72) Inventor: Kung-Jung Ho, Nantou City (TW)

(21) Appl. No.: 15/221,666

(22) Filed: Jul. 28, 2016

(51) Int. Cl. F16B 7/10

(52) U.S. Cl. CPC F16B 7/105

(57) ABSTRACT

A telescopic rod assembly includes a first rod and a second rod. The first rod includes a sliding slot, a first lateral wall formed around the sliding slot, and an engaging recess formed in the first lateral wall. The second rod is slidably mounted in the sliding slot and is movable between a slidable position and a fixed position. The second rod includes a flexible engaging protrusion integrally formed in an outer periphery of one side of the second rod. When the second rod is in the slidable position, the engaging protrusion is abutted against an inner surface of one side of the first lateral wall. When the second rod is in the fixed position, the engaging protrusion is engaged into the engaging recess.

### BACKGROUND OF THE INVENTION

The present invention relates to a telescopic rod assembly and, more particular, to a telescopic rod assembly capable of firmly positioned.

Taiwan Utility Patent No. M327,933 discloses a telescopic rod structure, which is composed of a male tube (10) and a female tube (20). The male tube (10) has a sliding block (14) extended from an outer periphery of a rear end of a body (13) and slidably received in an inner hole (21) of the female tube (20). The female tube (20) has a neck section (22) with a smaller diameter formed at a front end of the inner hole (21) and adapted to be inserted by the body (13) of the male tube (10). When the body (13) extends out of the female tube (20) with a maximum length, the sliding block (14) is resisted against the neck section (22). The inner hole (21) of the female tube (20) further has a resisting member (30) resisting against the male tube (10) so that when the male tube (10) is positioned with a minimum length, the male tube (10) is slidably moved in the female tube (20) to efficiently adjust a total length of the male and female tubes (10 and 20) and is unable to disengage from the female tube (20). The sliding block (14) is provided with a recess (15) adapted to receive a tenon (40) abutted against a spring (41). The female tube (20) is provided with a hole (24) located adjacent to the neck section (22). When the sliding block (14) is resisted against the neck section (22), the tenon (40) compressed by the spring (41) is engaged and positioned into the hole (24).

The above telescopic rod structure is complex. During the assembly of the telescopic rod, the tenon (40) and the spring (41) must first be assembled into the recess (15), and then the female tube (20) is slidably sleeved on the male tube (10). However, during the assembly of the male and female tubes (10 and 20), the tenon (40) is easy to eject out of the recess (15) due to the elastic force of the spring (41). Further, the above telescopic rod is positioned by the tenon (40) engaged in the hole (24) under the elastic force of the spring (41). It is unreliable under an external force, which may casually impact the male and female tubes (10 and 20) to cause the male and female tubes (10 and 20) disengaged from each other, so that the above telescopic rod structure cannot provide a firm engagement.

The present invention is, therefore, intended to obviate or at least alleviate the problems encountered in the prior art.

### BRIEF SUMMARY OF THE INVENTION

The present invention solves this need and other problems in the field of telescopic rod assemblies by providing a telescopic rod assembly including a first rod extending along an axis and a second rod slidably mounted in the first rod. The first rod includes a sliding slot extended along the axis, a first lateral wall formed around the sliding slot, and at least one engaging recess formed in the first lateral wall and interconnected with the sliding slot. The second rod is slidably mounted in the sliding slot and is movable relative to the first rod along the axis between a slidable position and a fixed position. The second rod includes at least one flexible engaging protrusion integrally formed in an outer periphery of one side of the second rod adjacent to the first rod. When the second rod is in the slidable position, the engaging protrusion is abutted against an inner surface of one side of the first lateral wall of the first rod adjacent to the sliding slot. When the second rod is in the fixed position, the engaging protrusion is engaged into the engaging recess.

One end of the engaging recess is interconnected with the sliding slot, and another end of the engaging recess is extended through the first lateral wall and is connected to an outer surface of the first lateral wall.

The first rod includes two engaging recesses arranged on two opposite sides of the first lateral wall, and the second rod includes two engaging protrusions respectively configured corresponding to the two engaging recesses.

The second rod includes a hollow slot extended along the axis, and a second lateral wall formed around the hollow slot. The second rod further includes a hollow recess formed on the second lateral wall and located adjacent to the engaging protrusion. One of four edges of the engaging protrusion is integrally connected to the second lateral wall, and the other three adjacent edges of the four edges of the engaging protrusion are surrounded by the hollow recess. When the second rod is in the fixed position, one end of the engaging protrusion adjacent to the hollow recess is engaged into the engaging recess and is abutted against an inner edge of the engaging recess.

In an example, the engaging recess is a square hole, and the engaging protrusion is a square sheet.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows a perspective view of a telescopic rod assembly according to the present invention.

FIG. 2 shows an exploded, perspective view of the telescopic rod assembly of FIG. 1.

FIG. 3 shows a cross-section view of the telescopic rod assembly of FIG. 1, and illustrates a second rod in a slidable position.

FIG. 4 shows another cross-section view of the telescopic rod assembly of FIG. 1, and illustrates the second rod in a fixed position.

FIG. 5 shows a partial, enlarged view of the telescopic rod assembly of FIG. 4.

All figures are drawn for ease of explanation of the basic teachings only; the extensions of the figures with respect to number, position, relationship, and dimensions of the parts to form the illustrative embodiments will be explained or will be within the skill of the art after the following teachings have been read and understood. Further, the exact dimensions and dimensional proportions to conform to specific force, weight, strength, and similar requirements will likewise be within the skill of the art after the following teachings have been read and understood.

Where used in the various figures of the drawings, the same numerals designate the same or similar parts. Furthermore, when the terms “first”, “second”, “third”, “fourth”, “end”, “portion”, “longitudinal”, “radial”, “diameter”, “width”, “thickness”, and similar terms are used herein, it should be understood that these terms have reference only to the structure shown in the drawings as it would appear to a person viewing the drawings and are utilized only to facilitate describing the illustrative embodiments.

### DETAILED DESCRIPTION OF THE INVENTION

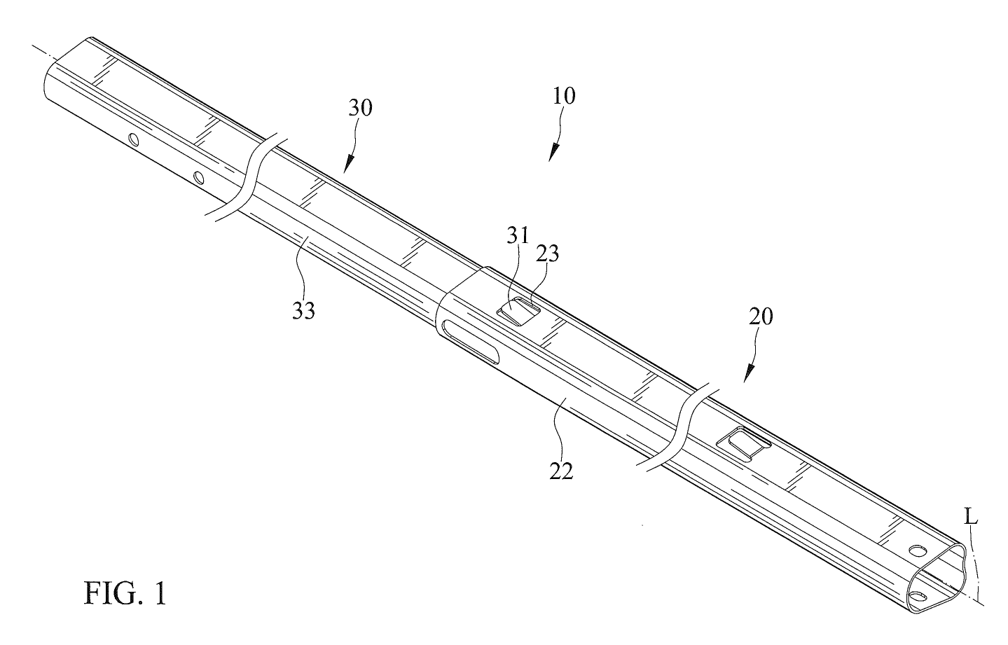

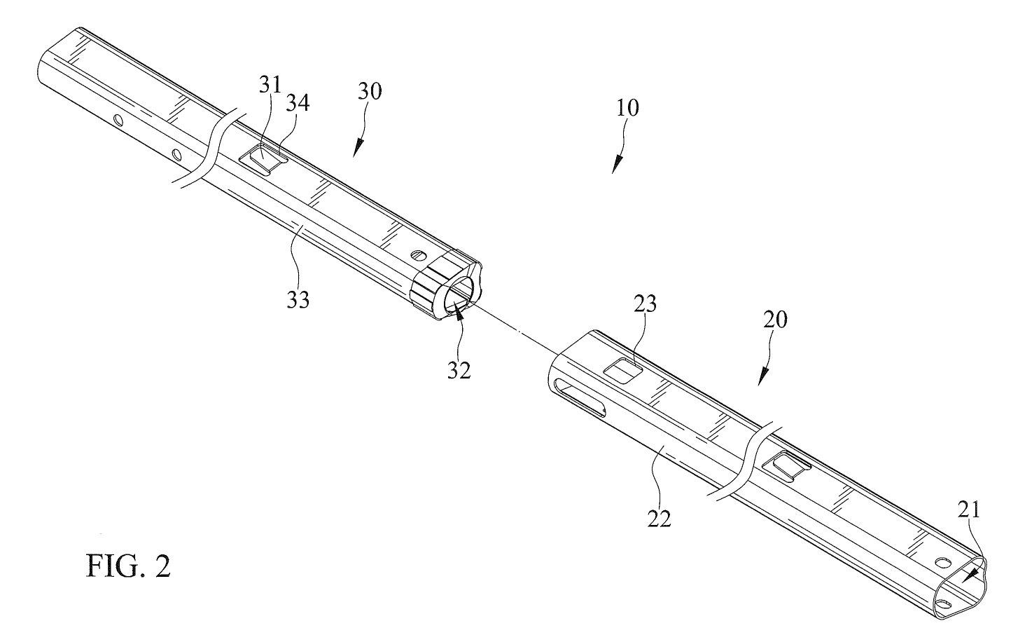

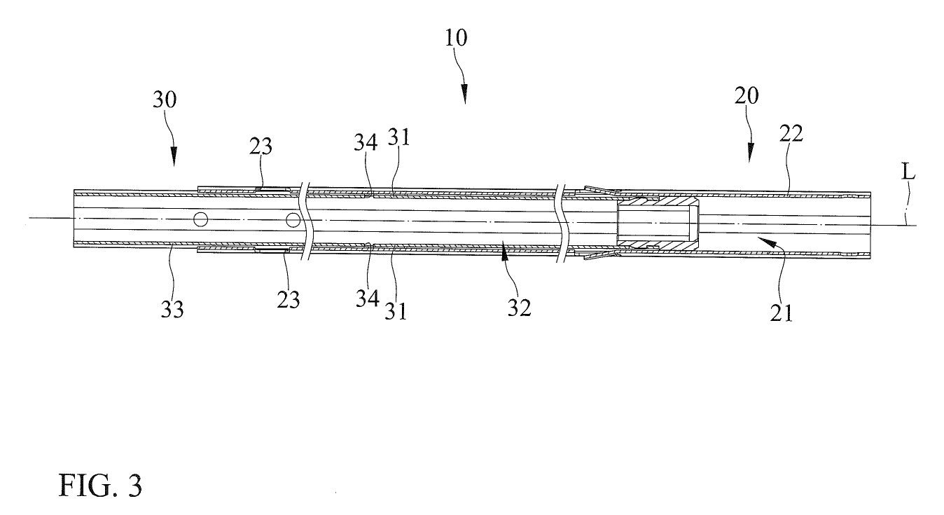

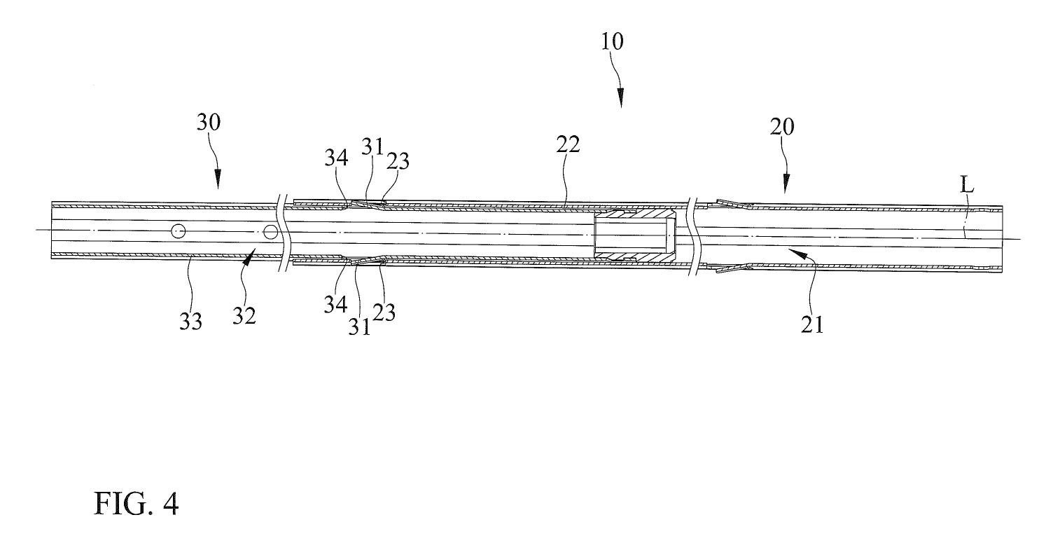

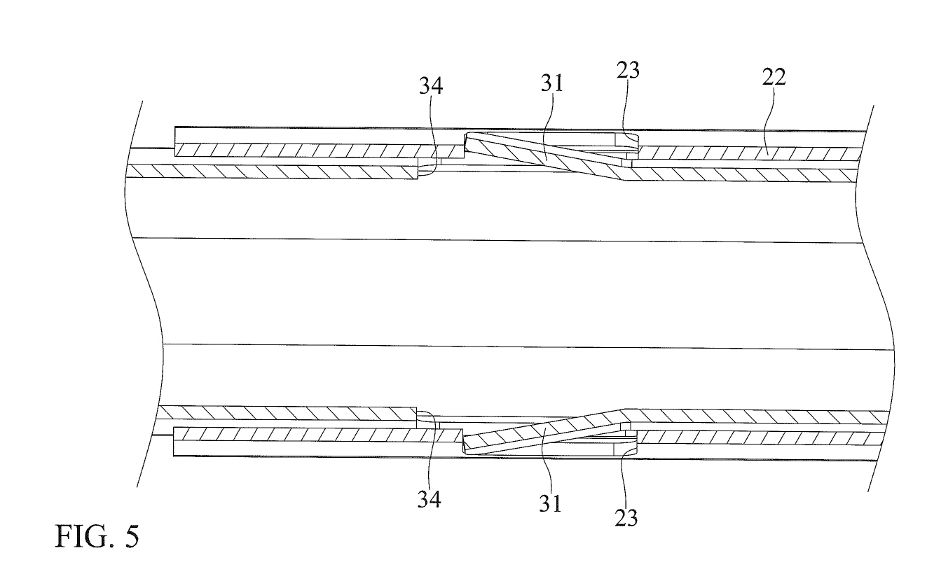

FIGS. 1-5 show a telescopic rod assembly 10 according to the present invention shown in the drawings. The telescopic rod assembly 10 includes a first rod 20 and a second rod 30 slidably mounted in the first rod 20.

The first rod 20 extends along an axis L. The first rod 20 includes a sliding slot 21 extended along the axis L, a first lateral wall 22 formed around the sliding slot 21, and at least one engaging recess 23 fonned in the first lateral wall 22 and interconnected with the sliding slot 21. One end of the engaging recess 23 is interconnected with the sliding slot 21, and another end of the engaging recess 23 is extended through the first lateral wall 22 and is connected to an outer surface of the first lateral wall 22. In the embodiment, the engaging recess 23 is a square hole, and the first rod 20 may include two engaging recesses 23 are arranged on two opposite sides of the first lateral wall 22.

The second rod 30 is slidably mounted in the sliding slot 21 of the first rod 20 and is movable relative to the first rod 20 along the axis L between a slidable position and a fixed position. The second rod 30 includes at least one flexible engaging protrusion 31 integrally formed in an outer periphery of one side of the second rod 30 adjacent to the first rod 20.

The second rod 30 includes a hollow slot 32 extended along the axis L, and a second lateral wall 33 formed around the hollow slot 32. The second rod 30 further includes at least one hollow recess 34 formed on the second lateral wall 33 and is located adjacent to the engaging protrusion 31. One of four edges of the engaging protrusion 31 is integrally connected to the second lateral wall 33, and the other three adjacent edges of the four edges of the engaging protrusion 31 are surrounded by the hollow recess 34. In the embodiment, the engaging protrusion 31 is a square sheet, and the second rod 30 may include two engaging protrusions 31 and two hollow recesses 34 respectively configured corresponding to the two engaging recesses 23.

When the second rod 30 is in the slidable position, the second rod 30 is movable relative to the first rod 20 along the axis L to provide a telescopic function, and the engaging protrusion 31 is abutted against an inner surface of one side of the first lateral wall 22 of the first rod 20 adjacent to the sliding slot 21.

When the second rod 30 is in the fixed position, one end of the engaging protrusion 31 adjacent to the hollow recess 34 is engaged into the engaging recess 23 and is abutted against an inner edge of the engaging recess 23 to provide a firm engagement between the first and second rods 20 and 30.

In view of the foregoing, the present invention has the following advantages:

When the second rod 30 is in the fixed position, one end of the engaging protrusion 31 adjacent to the hollow recess 34 is engaged into the engaging recess 23 and is abutted against an inner edge of the engaging recess 23 to provide a firm engagement between the first and second rods 20 and 30.

Moreover, the engaging recess 23 and the engaging protrusion 31 may be formed by stamping or sheet-metal to provide a faster processing speed and to provide a firm position function.

Thus since the illustrative embodiments disclosed herein may be embodied in other specific forms without departing from the spirit or general characteristics thereof, some of which forms have been indicated, the embodiments described herein are to be considered in all respects illustrative and not restrictive. The scope is to be indicated by the appended claims, rather than by the foregoing description, and all changes which come within the meaning and range of equivalency of the claims are intended to be embraced therein.

1. A telescopic rod assembly comprising:
a first rod extending along an axis, the first rod including a sliding slot extended along the axis, a first lateral wall formed around the sliding slot, and at least one engaging recess formed in the first lateral wall and interconnected with the sliding slot; and
a second rod slidably mounted in the sliding slot and movable relative to the first rod along the axis between a slidable position and a fixed position, with the second rod including at least one flexible engaging protrusion integrally formed in an outer periphery of one side of the second rod adjacent to the first rod;
wherein when the second rod is in the slidable position, the engaging protrusion is abutted against an inner surface of one side of the first lateral wall of the first rod adjacent to the sliding slot;
wherein when the second rod is in the fixed position, the engaging protrusion is engaged into the engaging recess.

2. The telescopic rod assembly as claimed in claim 1, with one end of the engaging recess interconnected with the sliding slot, and with another end of the engaging recess extended through the first lateral wall and connected to an outer surface of the first lateral wall.

3. The telescopic rod assembly as claimed in claim 1, with the first rod including two engaging recesses arranged on two opposite sides of the first lateral wall, and with the second rod including two engaging protrusions respectively configured corresponding to the two engaging recesses.

4. The telescopic rod assembly as claimed in claim 1, with the second rod including a hollow slot extended along the axis, and a second lateral wall formed around the hollow slot, with the second rod further including a hollow recess formed on the second lateral wall and located adjacent to the engaging protrusion, with one of four edges of the engaging protrusion integrally connected to the second lateral wall, with the other three adjacent edges of the four edges of the engaging protrusion surrounded by the hollow recess;
wherein when the second rod is in the fixed position, one end of the engaging protrusion adjacent to the hollow recess is engaged into the engaging recess and is abutted against an inner edge of the engaging recess.

5. The telescopic rod assembly as claimed in claim 4, with the engaging recess being a square hole, and with the engaging protrusion being a square sheet.

6. The telescopic rod assembly as claimed in claim 2, with the second rod including a hollow slot extended along the axis, and a second lateral wall formed around the hollow slot, with the second rod further including a hollow recess formed on the second lateral wall and located adjacent to the engaging protrusion, with one of four edges of the engaging protrusion integrally connected to the second lateral wall, with the other three adjacent edges of the four edges of the engaging protrusion surrounded by the hollow recess;
wherein when the second rod is in the fixed position, one end of the engaging protrusion adjacent to the hollow recess is engaged into the engaging recess and is abutted against an inner edge of the engaging recess.

7. The telescopic rod assembly as claimed in claim 6, with the engaging recess being a square hole, and with the engaging protrusion being a square sheet.

8. The telescopic rod assembly as claimed in claim 3, with the second rod including a hollow slot extended along the axis, and a second lateral wall formed around the hollow slot, with the second rod further including two hollow recesses formed on two opposite side of the second lateral wall and respectively located adjacent to the two engaging protrusions, with one of four edges of each engaging protrusion integrally connected to the second lateral wall, with the other three adjacent edges of the four edges of each engaging protrusion surrounded by the respective hollow recess;
wherein when the second rod is in the fixed position, one end of each engaging protrusion adjacent to the respective hollow recess is engaged into the respective engaging recess and is abutted against an inner edge of the respective engaging recess.

9. The telescopic rod assembly as claimed in claim 8, with each engaging recess being a square hole, and with each engaging protrusion being a square sheet.
